(19) United States
(12) Patent Application Publication
(10) Pub. No.: US 2026/0226683 A1
(43) Pub. Date: Aug. 6, 2026

(54) MULTI-AXIAL PULP MAKING FELT AND METHOD OF MAKING

(71) Applicant: ASTENJOHNSON INTERNATIONAL, INC., Charleston, SC (US)

(72) Inventors: David RHODES, Simpsonville, SC (US); Daniel DEMPSEY, Simpsonville, SC (US); John XU, Kanata (CA)

(73) Assignee: ASTENJOHNSON INTERNATIONAL, INC., Charleston, SC (US)

(21) Appl. No.: 19/149,184

(22) PCT Filed: Jan. 18, 2024
(86) PCT No.: PCT/US2024/011990

§ 371 Date: Jul. 18, 2025

Related U.S. Application Data
(60) Provisional application No. 63/439,968, filed on Jan. 19, 2023.

(51) Int. Cl. D21F 7/08; B32B 5/02; B32B 5/06; B32B 5/10; B32B 5/26; B32B 7/12; B32B 38/00; B32B 38/18; D21F 1/00; D21F 7/10

(52) U.S. Cl. CPC D21F 7/083; B32B 5/022; B32B 5/024; B32B 5/06; B32B 5/10; B32B 5/262; B32B 7/12; B32B 38/1841; D21F 1/0054; D21F 7/10; B32B 2038/008; B32B 2262/0261; B32B 2307/52; B32B 2307/7376; B32B 2433/00

(57) ABSTRACT

A press felt assembly for paper production, pulp sheet production, tissue production, or other production requiring surface imprinting. The press felt assembly including a base having a width and a length in a machine direction. The base being formed of a strip formed by generally MD oriented yarns in a planar yarn array that are oriented at a nonparallel angle to the true machine direction. A laminate composite is connected to the base. The laminate composite includes at least a base layer, a first adhesive layer coupled to an upper surface of the base layer, and a plurality of marking yarns coupled to an upper surface of the first adhesive layer. The plurality of marking yarns of the laminate composite are oriented in a generally machine direction.

### CROSS-REFERENCE TO RELATED APPLICATIONS

This application claims the benefit of U.S. Provisional Application No. 63/439,968, Jan. 19, 2023, the contents of which are incorporated herein by reference.

### FIELD OF INVENTION

The present disclosure concerns press felts intended for use in the press sections of paper, pulp, and/or tissue making machines. It is particularly concerned with press felt assemblies including a laminate composite connected to a multi-axial base for forming grooves in a paper or pulp web.

### BACKGROUND

Pulp products, such as pulp sheets, are known lignocellulosic fibrous materials prepared by chemically and/or mechanically separating cellulose fibers from wood, fiber crops, waste paper, or rags. In some known processes, raw wood is debarked and chipped and then the wood chips are cooked to remove lignin, which is an organic polymer that forms key structural materials in the support tissues (cell walls) of most plants. In other known processes, the wood chips can be ground to separate the fibers of the wood chips. The chemically or mechanically pulped wood chips are then cleaned by washing, screening, drying, and in some cases bleaching. Pulp products/sheets are the major raw material used in papermaking and the industrial production of other paper products.

Paper and pulp products are conventionally manufactured in a continuous process by directing a dilute stock slurry from a headbox onto a moving forming fabric in the forming section of a paper or pulp making machine. The forming fabric provides uniform support to the paper or pulp fibers in the stock while allowing a sufficient portion of the water to drain through, so that upon reaching the end of the forming section a very wet but cohesive fiber web remains. This web is then transferred to the press section where it is transported on one or several press felts through at least one press nip so that a further proportion of water can be removed by mechanical means. Following pressing, the web is then passed to the dryer section of the machine where it is conveyed on one or more dryer fabrics so that the remainder of water (down to a desired moisture content) is removed by evaporation. In pulp sheet forming operations, the dryer section can be an in-line run of heated ovens, while in papermaking operations, the dryer section typically includes a series of heated rolls around which the dryer fabric carries the paper web. Press felts play an important role in the paper and pulp making processes; they provide a reservoir into which water that is expressed from the web can be carried for subsequent removal, and they provide a uniform, surface upon which the web is conveyed as it passes through the press nips. Press felts are typically constructed using a base fabric into which is needled a number of layers of a relatively fine fibrous batt material.

Until recently, press felts were generally made using one of two methods. In the first method, the base fabric was woven endlessly as a tube according to the size required to suit the press section into which it was to be installed, and with or without a seam region at each of the lateral side edges. Once this base fabric was completed, layers of batt material were then needled into it; the press felt was then finished according to known methods and, when installed, was either joined on the machine using features of the seam region or, if seamless, slipped over the press section area for which it was made. In the second method, the base fabric was woven flat to the width and length of the final felt, a seam region created at the opposing longitudinal ends, and layers of batt needled onto the base fabric. The base fabric was typically a multilayer weave construction to provide dimensional stability and void volume to the final press felt. The fabric was installed by passing it through the press section while attached to the older fabric it was to replace, and then joined at the prepared seam area usually by means of a pintle. Both methods of constructing the press felts have been in use for a number of years, and both are time consuming and expensive methods for producing the press felts.

More recently, multiaxial constructions for press felts have also been provided, such as described in U.S. Pat No. 5,268,076 and U.S. Pat. No. 5,360,656. However, these arrangements have some shortcomings and have generally not been used for pulp making.

However, there is still a need for a new press felt design that is less time consuming and less expensive to produce, as compared to the previous press felt designs described above, that also provides further benefits in terms of additional functionality and/or reducing processing costs in use on pulp or papermaking equipment.

### SUMMARY

In one aspect, the present disclosure is directed to a press felt assembly. The press felt assembly includes a multi-axial base having a cross-machine direction width, a machine direction length in a machine direction, and the multi-axial base can be formed of a strip formed by a planar yarn array oriented at a nonparallel angle to the machine direction. A laminate composite is connected to a surface of the multi-axial base. The laminate composite includes a nonwoven base layer extending in the machine direction, a first adhesive layer coupled to an upper surface of the base layer, and a plurality of marking yarns or other surface topography forming material coupled to an upper surface of the first adhesive layer. The plurality of marking yarns can be oriented in a generally machine direction.

In one embodiment, the generally machine direction comprises +/−3-5 degrees of a theoretical machine direction.

In one embodiment, the plurality of marking yarns are oriented in a true machine direction.

In one embodiment, the true machine direction comprises +/−1 degree of a theoretical machine direction.

In one embodiment, a yarn density of the plurality of marking yarns is less than 75%, creating a plurality of ridges and grooves that extend in the true machine direction.

In one embodiment, the strip is a woven strip formed of interwoven warp and weft yarns, and the warp yarns extend at the nonparallel angle to the machine direction.

In one embodiment, the strip is a nonwoven strip that includes yarns that extend at the nonparallel angle to the machine direction.

In one embodiment, the laminate composite is connected to the multi-axial base through a needling process.

In one embodiment, at least one layer of a fibrous batt material connected to the laminate composite and the multi-axial base through a needling process.

In one embodiment, the base layer is constructed from a nonwoven nylon backing material.

In one embodiment, the nonwoven nylon backing material includes a plurality of thermally bonded spun nylon fibers.

In one embodiment, the first adhesive layer is constructed from a low-melt nylon adhesive web.

In one embodiment, each of the plurality of marking yarns are constructed from a plurality of twisted multifilament yarns.

In one embodiment, each of the plurality of marking yarns are constructed from a large monofilament yarn having a diameter greater than 0.5 mm.

In one embodiment, a second adhesive layer is coupled to the plurality of marking yarns, such that each of the plurality of marking yarns are positioned between the first adhesive layer and the second adhesive layer. A nonwoven top layer extends in the machine direction, the top layer can be coupled to the second adhesive layer. A scrim material is coupled to an upper surface of the second adhesive layer, such that the scrim material is positioned between the second adhesive layer and the top layer.

In one embodiment, the scrim material is constructed from one or more of a high-strength multifilament twisted with a low-melt adhesive and a monofilament yarn, a cabled monofilament yarn, a multifilament yarn, a twisted multifilament yarn, or any combination thereof, and wherein at least one intersecting yarn system of the scrim material contains a low-melt polymeric component.

In one embodiment, the planar yarn array of the multi-axial base is oriented at the nonparallel angle with respect to the plurality of marking yarns of the laminate composite.

In one embodiment, the plurality of marking yarns of the laminate composite are configured to form a plurality of grooves in a surface of a production material during a production process, each of the plurality of grooves being in the true machine direction.

In another aspect, the present disclosure is directed to a method of producing a press felt assembly. The method including producing and providing a multi-axial base including a planar yarn array; laminating a laminate composite, the laminate composite comprising a base layer, a first adhesive layer adjacent the base layer, and a plurality of marking yarns or other surface topography forming material coupled to the first adhesive layer; and connecting the laminate composite to the multi-axial base through a needling process, such that each of the plurality of marking yarns of the laminate composite are oriented generally parallel to a true machine direction of the press felt assembly.

In one embodiment, generally parallel to the true machine direction comprises +/−3-5 degrees of a theoretical machine direction.

In one embodiment, each of the plurality of marking yarns are oriented parallel to the true machine direction, wherein the true machine direction comprises +/−1 degree of a theoretical machine direction.

In one embodiment, the method further includes connecting at least one layer of a fibrous batt material to the press felt assembly through the needling process.

In one embodiment, producing the multi-axial base includes spirally winding a fabric strip around a first roller and a second roller; joining adjacent edges of the wound fabric strip to produce a double layer fabric structure; coupling first seam loops at a first end of the double layer fabric structure to second seam loops at a second end of the double layer fabric structure; and collapsing the coupled double layer fabric structure to form the multi-axial base with a cross-machine direction width and a machine direction length extending in the machine direction; wherein generally MD oriented yarns of the planar yarn array of the woven multi-axial base are oriented at a nonparallel angle to the true machine direction.

In one embodiment, the plurality of marking yarns of the laminate composite are configured to form a plurality of grooves that are in the true machine direction in a surface of a production material during a production process.

In one embodiment, the laminate composite further includes a second adhesive layer coupled to the plurality of marking yarns, such that each of the plurality of marking yarns are positioned between the first adhesive layer and the second adhesive layer; a nonwoven top layer extending in the machine direction, the top layer coupled to the second adhesive layer; and a scrim material coupled to an upper surface of the second adhesive layer, such that the scrim material is positioned between the second adhesive layer and the top layer.

In one embodiment, each of the plurality of marking yarns are constructed from a plurality of twisted multifilament yarns.

In one embodiment, each of the plurality of marking yarns are constructed from a large monofilament yarn having a diameter greater than 0.5 mm.

According to another aspect, the present disclosure is directed to a method of forming grooves in a pulp web during a pulp sheet production process. The method including: providing a press felt assembly including: a multi-axial base including generally MD oriented yarns of a planar yarn array that are oriented at a nonparallel angle to a true machine direction; and a laminate composite connected to the multi-axial base through a needling process. The laminate composite including a base layer, a first adhesive layer adjacent the base layer, and a plurality of marking yarns coupled to the first adhesive layer; wherein each of the plurality of marking yarns of the laminate composite are oriented in the true machine direction. The method further including applying a paper web to the press felt assembly to produce the pulp web; and forming, by each of the plurality of marking yarns of the laminate composite, a plurality of grooves in the pulp web, wherein each of the plurality of grooves in the pulp web are oriented in the true machine direction.

### BRIEF DESCRIPTION OF THE DRAWING(S)

The foregoing Summary as well as the following Detailed Description will be best understood when read in conjunction with the appended drawings, which illustrate a preferred embodiment of the disclosure. In the drawings:

FIG. 1 is a schematic illustration of a spiral winding process used to produce a multi-axial base;

FIG. 2 is an illustration of the multi-axial base after spiral winding and removal from the apparatus shown in FIG. 1;

FIG. 3 is a close-up view of folded edge regions of the multi-axial base shown in FIG. 2;

FIG. 4 is an illustration of a seam region in the multi-axial base shown in FIG. 3;

FIG. 5 is an illustration of a fibrous batt material before coupling to the multi-axial base;

FIG. 6 is a top view of an exemplary press felt assembly including the multi-axial base and a laminate composite;

FIG. 7 is an exploded isometric view of the laminate composite of FIG. 6;

FIGS. 8A-8C are a series of views showing the steps in an example construction of the laminate composite according to the present disclosure;

FIGS. 9A-9B illustrate a method for producing an endless nonwoven laminate composite marking layer; and

FIGS. 10A-10C illustrate different methods for joining ends of the nonwoven laminate composite marking layer.

### DETAILED DESCRIPTION

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terms “generally” and “approximately” are to be construed as within 10% of a stated value or ratio. The terminology includes the words specifically noted above, derivatives thereof, and words of similar import.

Further, as used herein, the following terms have the meanings indicated:

“MD” (or “theoretical MD”) refers to a machine direction in the paper and pulp making machines from the headbox to the dryer section and is the longitudinal direction of the press felt. “True MD” refers to a direction that is within +/−1 degree of a theoretical MD. “Generally MD” refers to a direction that is within +/−3-5 degrees of the theoretical MD. “CD” refers to the cross-machine direction, or a direction perpendicular to the machine direction in the plane of the fabric. Unless otherwise specified, the term “yarn” or “yarns” refers to a continuous length of either single or cabled polymeric monofilament such as would be used in the manufacture of the base fabrics of the invention, while the term “fiber” or “fibers” refers to relatively small diameter polymeric materials such as those commonly used in batt or scrim materials which fibers have a very small decitex (dtex) (mass in grams per 10,000 meters of fiber).

“Seam region” refers to the exposed yarn loops of the MD yarns at the CD fold areas at the opposing MD ends of the press felt. The term “array” refers to a generally planar group of mutually parallel yarns which are not interwoven or interconnected with one another by interlacing. The term “fibrous scrim” refers to bonded cohesive open network of fine fibers made, for example, by spinning and thermally bonding continuous filaments of polyamide into a drapable, conformable textile like material whose component fibers having a dtex that is in the range of 1 to 10 and an air permeability between about 100 cfm (~1,560 m3/m2/hr) and about 2000 cfm (~31,000 m3/m2/hr) or higher. “Orthogonal” or “perpendicular” as used herein with respect to the CD and MD yarns means generally within about 85° to 95° based on the deviation from true perpendicular created by the spiral winding of the MD yarns in the first yarn array.

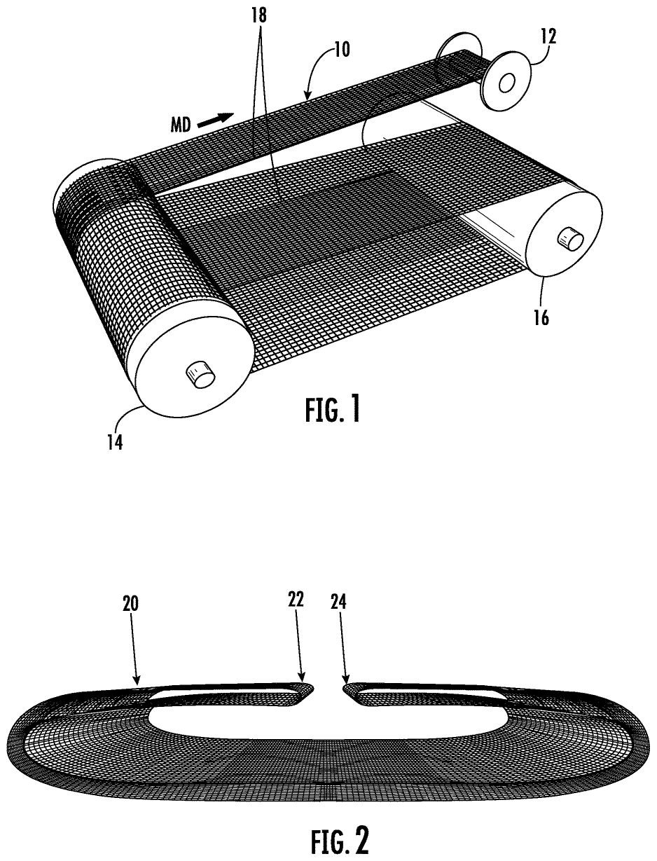

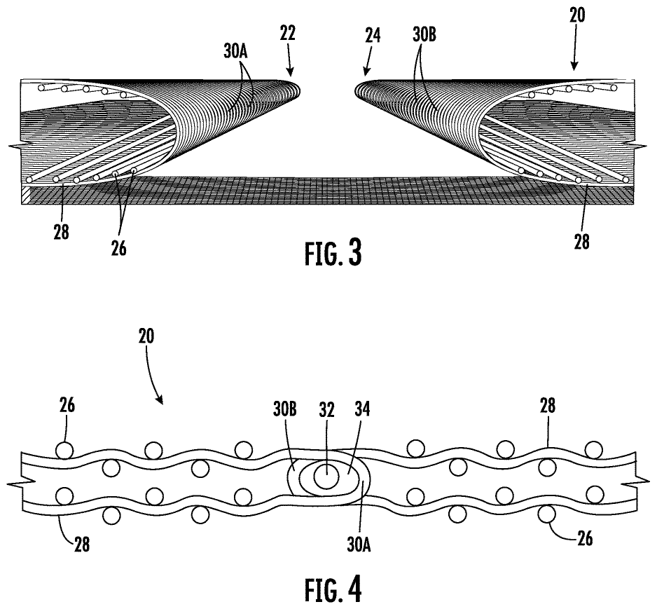

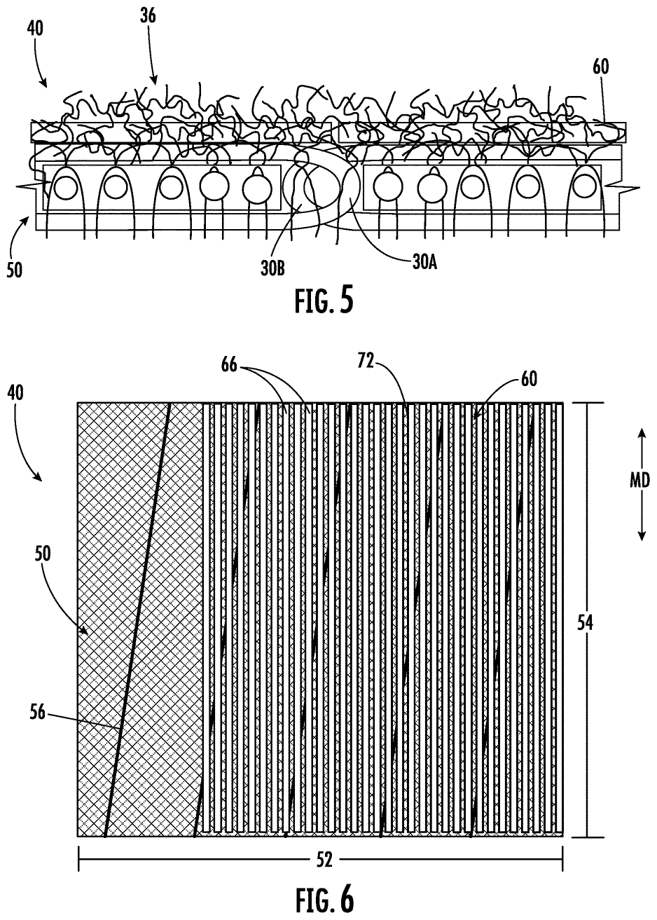

FIG. 1 is a schematic illustration of a spiral winding process used to produce a multi-axial base 50. FIG. 2 is an illustration of the multi-axial base 50 after spiral winding and removal from the apparatus shown in FIG. 1. FIG. 3 is a close-up view of folded edge regions of the multi-axial base 50 shown in FIG. 2. FIG. 4 is an illustration of a seam region in the multi-axial base 50 shown in FIG. 3. FIG. 5 is an illustration of a fibrous batt material connected to the multi-axial base 50.

As shown in FIG. 1, press felts can be manufactured using a relatively narrow (about 1 meter wide) fabric strip 10 which is spirally wound and joined by various methods along their lateral edges 18 during production so as to provide integrity to the resulting fabric. This so-called spirally wound or “multi-axial” manufacturing process is advantageous over previous manufacturing approaches because it removes the need for the very wide industrial looms previously used to make the base fabric. Instead, a relatively narrow high-speed loom is used to produce a continuous, usually single layer strip of a woven fabric which is subsequently spirally or helically wound around a first roller 14 and a second roller 16 to build up an endless open fabric tube at a width and length determined to produce the finished fabric. The tube is then removed from the first roller 14 and the second roller 16, collapsed flat to provide a double layer fabric structure 20 (FIG. 2), and then one or more layers of batt material are needled into it (FIG. 5). A seam region is provided by removing a portion of the cross-machine direction (CD) yarns 26 at opposing first fold region 22 and second fold region 24 of the collapsed tube to expose seam loops 30A and 30B of the MD yarns 28 (FIG. 3), which can be intermeshed prior to being joined together by a seaming element, such as a pintle 32 or the like extending through the intermeshed seam loops 30A, 30B. Each of the previously mentioned production steps will be discussed in further detail below.

Referring to FIG. 1, which illustrates a spirally wound or “multi-axial” manufacturing process, a length of the fabric strip 10 is paid off a spool 12 (or other feed source) and the fabric strip 10 is spirally or helically wound about the opposing first roller 14 and second roller 16 so that the lateral or longitudinal edges 18 of each successive turn either abut or overlap one another. In some examples, the fabric strip 10 can be a woven strip formed of interwoven warp and weft yarns, with the warp yarns extending at a nonparallel angle to the machine direction MD, typically by about 3-5°. In other examples, the fabric strip 10 can be a nonwoven strip that includes yarns that extend at nonparallel angle to the machine direction MD, typically by about 3-5°. During assembly, each adjacent turn of the fabric strip 10 is bonded to the next by a chosen bonding process, such as stitching, welding, gluing, or other suitable means. Each adjacent turn of the fabric strip 10 is laid parallel to the next and usually oriented or canted at a small angle (3-5°) relative to the true machine direction MD of the finished fabric as it is spirally wound. Once the desired width and length of the spirally wound fabric has been obtained, the textile material is cut from the spool 12 (or other feed source) and the loosely cohesive spirally wound fabric is removed from the first roller 14 and the second roller 16. As shown in FIG. 2, following removal, the fabric can be laid flat to provide a double layer fabric structure 20 with an opposing first fold region 22 and second fold region 24. The side edges are trimmed so that they are parallel to the true machine direction MD.

Referring to FIG. 3, which is a close-up view of the first fold region 22 and the second fold region 24 of the spirally wound double layer fabric structure 20 shown in FIG. 2, a portion of the CD yarns 26 are removed at the opposing first fold region 22 and second fold region 24. This exposes the MD yarns 28 of the double layer fabric structure 20 so that the seam loops 30A and 30B may be used to form a seam in the spirally wound fabric, as shown in FIG. 4. Further, as shown in FIG. 4, the double layer fabric structure 20 can be joined by intermeshing first seam loops 30A at the first fold region 22 of a first end of the double layer fabric structure 20 to second seam loops 30B at the second fold region 24 of a second end of the double layer fabric structure 20. Then a pintle 32 (or other similar device) can be inserted across the length of a channel 34 formed between the seam loops 30A and 30B to form the multi-axial base 50.

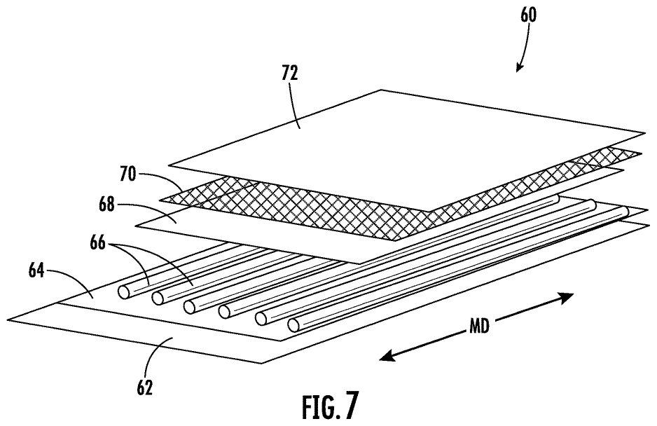

FIG. 5 is a cross-sectional view through the seam region of the press felt assembly 40. FIG. 6 is a top view of a press felt assembly 40 including the multi-axial base 50 and a laminate composite 60. FIG. 7 is an exploded isometric view of the laminate composite 60 illustrated in FIG. 6. FIGS. 5-7 will be discussed together.

The press felt assembly 40 includes the multi-axial base 50 described in regard to FIGS. 1-4 and a laminate composite 60 connected to a surface of the multi-axial base 50, preferably by needling on a fibrous batt material 36. More specifically, after the seam loops 30A and 30B of the multi-axial base 50 are joined and the laminate composite 60 is placed on a surface of the multi-axial base 50, at least one layer of a relatively fine fibrous batt material 36 can be applied and needled into the multi-axial base 50 and the laminate composite 60 to form the press felt assembly 40. In some embodiments, the at least one layer of fibrous batt material 36 can be a relatively small diameter polymeric material with fibers having a very small decitex (dtex) (mass in grams per 10,000 meters of fiber). In some examples, each of the relatively small diameter polymeric materials can have a diameter ranging between 3.3 decitex to 122 decitex.

In some examples, the laminate composite 60 can be coupled to the paper or pulp side surface of the multi-axial base 50, which is the surface upon which the paper or pulp product is carried through the papermaking or pulp making machine, respectively. In the illustrated embodiment, the multi-axial base 50 is a woven multi-axial base 50 configured for use as a press felt base, as described in regard to FIGS. 1-4. But it is to be understood that in other embodiments the multi-axial base 50 can be a nonwoven multi-axial base 50 configured for use as a press felt base.

In the embodiment shown, the multi-axial base 50 includes a CD width 52, an MD length 54 extending in a machine direction MD, and a planar yarn array 56. The CD width 52 is the respective width of the multi-axial base 50 in a direction perpendicular to the machine direction MD of the press felt assembly 40. The MD length is the respective length of the multi-axial base 50 in a direction parallel to the machine direction MD of the press felt assembly 40. In some examples, the planar yarn array 56 can be formed by a woven fabric strip 10, discussed above. In other examples, the planar yarn array 56 can be formed from yarns of a nonwoven strip 10, discussed above. In either example, the planar yarn array 56 includes generally MD oriented yarns that are oriented at a nonparallel angle to the true machine direction MD of the press felt assembly 40, as shown in FIG. 6, due to the spirally wound multiaxial construction.

As shown in the embodiment illustrated in FIG. 7, the laminate composite 60 can include a base layer 62, a first adhesive layer 64, a plurality of marking yarns 66 or other surface topography forming material, a second adhesive layer 68, a scrim material 70, and a top layer 72. Layers 62, 64, 66, 68, 70, and 72 can be arranged consecutively in a stacked configuration from the base layer 62 to the top layer 72. Further, layers 62, 64, 66, 68, 70, and 72 can be coupled together through a lamination process, such that the final laminated laminate composite 60 is a generally flat sheet that can be easily coupled to the multi-axial base 50, as shown in FIG. 6. In other non-illustrated embodiments, the laminate composite 60 can include only one of the base layer 62 or the top layer 72, and only one of the first adhesive layer 64 or the second adhesive layer 68. As such, other embodiments of the laminate composite 60 can include less than the six individual layers illustrated in FIG. 7.

As illustrated in FIG. 6, the laminate composite 60 can have a length in the machine direction MD that is equal to the MD length 54 of the multi-axial base 50 (here shown flat prior to the ends being joined together for illustrative purposes). Further, although not shown, it is to be understood that the laminate composite 60 can have a width in the cross-machine direction that is equal to the CD width 52 of the multi-axial base 50, or can be assembled from strips to reach the CD width 52. In the example shown in FIG. 6, the laminate composite 60 is not shown as having the same width as the multi-axial base 50. But it is to be understood that FIG. 6 shows only a partial assembly, and the laminate composite 60 can have additional strips added in order to have a width equal to the CD width 52 of the multi-axial base 50.

The base layer 62 of the laminate composite 60 is the lowermost or bottommost layer of the laminate composite 60 in the orientation shown in FIG. 7. Further, the base layer 62 is the layer of the laminate composite 60 positioned directly adjacent and abutting the multi-axial base 50 when the laminate composite 60 is connected to the multi-axial base 50. In some embodiments, the base layer 62 can have a length equal to the MD length 54 and a width equal to the CD width 52. Alternatively, in some embodiments, the base layer 62 can have a length equal to the MD length 54, and is formed as a strip that has a width less than the CD width 52. In some embodiments, the base layer 62 can be a nonwoven base layer 62. Further, in some embodiments, the base layer 62 can be constructed from a nonwoven nylon backing material, such as, for example, a plurality of thermally bonded spun nylon fibers. In other embodiments, the base layer 62 can be constructed from any other suitable polymeric material. The base layer 62 is a thin layer of material configured to support and enclose other components of the laminate composite 60.

In the orientation shown in FIG. 7, the first adhesive layer 64 is coupled to an upper surface of the base layer 62. In some embodiments, the first adhesive layer 64 can have a length and width equal to the MD length 54 and the CD width 52, respectively. Alternatively, in some embodiments, the first adhesive layer 64 can have a length equal to the MD length 54, and is formed as a strip that has a width less than the CD width 52. Further, in some examples, the first adhesive layer 64 can be constructed from a low-melt nylon adhesive web. In other examples, the first adhesive layer 64 can be constructed from any other low-melt polymeric web. The first adhesive layer 64 is configured to secure and couple other components of the laminate composite 60 together, such as the base layer 62 and the plurality of marking yarns 66.

Each of the plurality of marking yarns 66 are coupled to an upper surface of the first adhesive layer 64. In the embodiment shown, the plurality of marking yarns 66 comprise a plurality of individual twisted yarns 66 spaced equally across a width of the base layer 62 and the first adhesive layer 64. In other embodiments, the plurality of marking yarns 66 can be large monofilament yarns 66 having a diameter greater than 0.5 mm. It is to be understood that either the twisted yarns or the large monofilament yarns can be utilized as the plurality of marking yarns 66, depending on the specific application in which the laminate composite 30 is to be used.

Further, each of the plurality of marking yarns 66 extend axially along the base layer 62 and the first adhesive layer 64 in a direction parallel to a lengthwise direction of the base layer 62 and the first adhesive layer 64. As such, in the illustrated embodiment, each of the plurality of marking yarns 66 are preferably oriented in the true machine direction MD of the press felt assembly 40. In other embodiments, each of the plurality of marking yarns 66 can be oriented in the generally machine direction MD (i.e., at a non-parallel angle with respect to the true machine direction MD) of the press felt assembly 40. Further, in some embodiments, the individual yarns 66 of the laminate composite 66 are preferably equally spaced across the width of the base layer 62 and the first adhesive layer 64. In other embodiments, the individual yarns 66 can have a varied spacing across the width of the base layer 62 and the first adhesive layer 64. Therefore, the plurality of marking yarns 66 can be spaced and oriented as needed to achieve a desired impression on the paper web, pulp web, or other production material surface.

In some embodiments, a yarn density of the plurality of marking yarns 66 can be less than 75%. In some examples, each of the plurality of marking yarns 66 can be constructed from a plurality of twisted multifilament yarns. In another example, each of the plurality of marking yarns 66 can be constructed from any multifilament, monofilament (e.g., a large monofilament having a diameter greater than 0.5 mm), or combination of fiber types that can be twisted or grouped together to produce the desired surface effect. The plurality of marking yarns 66 of the laminate composite 60 form a plurality of features that are ultimately raised above a surface of the press felt assembly, once assembled. As such, the plurality of marking yarns 66 of the laminate composite 60 are configured to form a plurality of ridges, grooves, or other desired pattern in a paper or pulp web that extend in a desired direction. For instance, in some embodiments, the plurality of ridges, grooves, or other desired pattern can be formed in the true machine direction MD during the paper or pulp making production, discussed further below. In other embodiments, the plurality of ridges, grooves, or other desired pattern can be formed in the generally machine direction MD during the paper or pulp making production.

In some embodiments, other surface topography forming materials can be utilized, such as shapes of patterns formed of molded or otherwise formed polymeric material that can be held in position by a base layer and at least one adhesive layer prior to positioning on and needling to the multi-axial base 50.

In the orientation shown in FIG. 7, the second adhesive layer 68 is coupled to the plurality of marking yarns 66, such that each of the plurality of marking yarns 66 are positioned between the first adhesive layer 64 and the second adhesive layer 68. Further, the second adhesive layer 68 is positioned between the plurality of marking yarns 66 and the scrim material 70, such that the second adhesive layer 68 is positioned adjacent and abutting the scrim material 70. In some embodiments, the second adhesive layer 68 can have a length and width equal to the MD length 54 and the CD width 52, respectively. Alternatively, in some embodiments, the second adhesive layer 68 can have a length equal to the MD length 54, and is formed as a strip that has a width less than the CD width 52. Further, in some examples, the second adhesive layer 68 can be constructed from a low-melt nylon adhesive web. In other examples, the second adhesive layer 68 can be constructed from any other low-melt polymeric web. The second adhesive layer 68 can be configured to secure and couple other components of the laminate composite 60 together, such as the plurality of marking yarns 66 and the scrim material 70.

The scrim material 70 can be coupled to an upper surface of the second adhesive layer 68 and coupled to a lower surface of the top layer 72. As such, the scrim material 70 can be positioned between the second adhesive layer 68 and the top layer 72. In some examples, the scrim material 70 can have a length and width equal to the length and width, respectively, of the base layer 62 and/or the top layer 72. In other examples, the scrim material 70 can have a length and width less than the length and width, respectively, of the base layer 62 and/or the top layer 72. In some examples, the scrim material 70 can be configured to be used as a reinforcement material, providing support and rigidity to the laminate composite 60. In other examples, the scrim material 70 can be used to add extra marking ability into the paper web, pulp web, or other production material. For example, the scrim material 70 can be used to add ridges, grooves, or other desired patterns in the production material, in addition to the plurality of marking yarns 66 of the laminate composite 60.

In some examples, the scrim material 70 can be constructed from a high-strength multifilament and a low-melt adhesive material that are twisted together. In other examples, the scrim material 70 can be constructed from monofilament yarn or a cabled monofilament yarn. Further, in some examples, the scrim material 70 can be constructed from both a high-strength multifilament twisted with a low-melt adhesive, and a monofilament yarn or a cabled monofilament yarn. In further examples, the scrim material 70 can be constructed from multifilament yarn, twisted multifilament yarn, or any combination of yarn types previously disclosed. In an exemplary embodiment, at least one of the intersecting yarn systems of the scrim material 70 contains a low-melt polymeric component to allow fusing of the web component. As illustrated in the embodiment shown in FIG. 7, the scrim material 70 can be constructed such that the scrim material 70 forms a web-like structure. In other embodiments, the scrim material 70 may not form a web-like structure. Further, in some examples, the scrim material 70 can be formed from a nonwoven scrim material.

The top layer 72 of the laminate composite 60 is the uppermost layer of the laminate composite 60, in the orientation shown in FIG. 7. Further, the top layer 72 is the layer of the laminate composite 60 positioned furthest away from the multi-axial base 50 when the laminate composite 60 is coupled to the multi-axial base 50. In some embodiments, the top layer 72 can have a length equal to the MD length 54 and a width equal to the CD width 52. Alternatively, in some embodiments, the top layer 72 can have a length equal to the MD length 54, and is formed as a strip that has a width less than the CD width 52. In some embodiments, the top layer 72 can be a nonwoven top layer 72. Further, in some embodiments, the top layer 72 can be constructed from a nonwoven nylon backing material, such as, for example, a plurality of thermally bonded spun nylon fibers. In other embodiments, the top layer 72 can be constructed from any other suitable polymeric material. The top layer 72 is a thin layer of material configured to enclose other components of the laminate composite 60. More specifically, the top layer 72 can be coupled to the scrim material 70 such that the scrim material 70 is positioned between the second adhesive layer 68 and the top layer 72. In some embodiments, in which the scrim material 70 is not included in the laminate composite 60, the top layer 72 can be coupled to the second adhesive layer 68. Further, in some embodiments, each of the top layer 72, the scrim material 70, and the second adhesive layer 68 may not be included in the laminate composite 60.

After layers 62, 64, 66, 68, 70, and 72 are laminated together through known lamination processes, the laminate composite 60 includes a generally flat sheet shape with a plurality of raised humps, or other desired pattern, at the locations of the plurality of marking yarns 66, other surface topography forming material, and/or the scrim material 70. Further, after the lamination process, the laminate composite 60 includes a consecutively stacked configuration from the base layer 62 to the top layer 72. After lamination and production of the laminate composite 60, the laminate composite 60 can be connected to the multi-axial base 50 by needling batt material 36 as shown in FIG. 5 through the laminate composite 60 and the multi-axial base 50 to fixedly connect the laminate composite 60 to the multi-axial base 50 for use in a paper, pulp sheet, and/or tissue production process, among other production processes. Further, after connecting the laminate composite 60 to the multi-axial base 50, an axial direction of each of the plurality of marking yarns 66 can be oriented preferably in the true machine direction MD, or in any other desired pattern. In some embodiments, after connecting the laminate composite 60 to the multi-axial base 50, an axial direction of each of the plurality of marking yarns 66 can be oriented in the generally machine direction MD. Further, as shown best in FIG. 6, an axial direction of each of the plurality of marking yarns 66 of the laminate composite 60 can be oriented at a nonparallel angle relative to the yarns of the generally MD oriented yarns of the planar yarn array 56 of the multi-axial base 50.

The press felt assembly 40 including the multi-axial base 50 and the laminate composite 60 can be used in a paper web, pulp sheet, and/or tissue making production process to produce an improved paper sheet, pulp sheet, and/or tissue, as compared to previous products produced using previous press felts. More specifically, according to one step of the paper or pulp sheet production process, a paper or pulp web from the forming section can be carried by the press felt assembly 40. Here, the plurality of marking yarns 66 of the laminate composite 60 form a plurality of grooves and ridges in the paper or pulp web, due to the plurality of marking yarns 66 being raised above the generally flat surface of the laminate composite 60 coupled to the multi-axial base 50. Since an axial direction of each of the plurality of marking yarns 66 is oriented in the true machine direction MD, each of the plurality of grooves and ridges in the paper or pulp web will likewise be oriented in the true machine direction MD.

In other words, the plurality of marking yarns 66 of the laminate composite 60 form grooves and/or a grooved appearance in the paper or pulp web during the paper or pulp sheet production process, respectively. Due to the axial orientation of each of the plurality of marking yarns 66 being preferably in the true machine direction MD, the grooves and/or grooved appearance in the paper or pulp web are also oriented in the true machine direction MD. As discussed, in other embodiments, the grooves and/or grooved appearance in the paper or pulp web can be oriented in the generally machine direction MD. Further, the grooves of the paper or pulp web are formed by pressing the paper or pulp web onto the surface of the press felt assembly 40 using a nip roll. Thereby imprinting the paper or pulp web with grooves from each of the raised plurality of marking yarns 66 in the laminate composite 60, which is positioned on the paper or pulp side surface of the press felt assembly 40, respectively.

The press felt assembly 40 including the multi-axial base 50 and the laminate composite 60 is a press felt design that replaces conventional/previous base structures for press felts used in the paper or pulp sheet production processes. The press felt assembly 40 including the multi-axial base 50 and the laminate composite 60 is cheaper and faster to produce compared to previous base structures and press felts, making the press felt assembly 40 advantageous and more desirable. Further, the press felt assembly 40 creates grooves and/or a grooved appearance in the paper or pulp web, which improves drying efficiency particularly in pulp web drying applications, by increasing surface area and allowing air to circulate into the grooves which in turn decreases the drying time of the paper or pulp web, respectively.

In addition, the press felt assembly 40 creating grooves and/or a grooved appearance, particularly for a pulp web, aids in stacking and guiding the paper or pulp web to improve the stacking speed and accuracy for cut pulp sheets. The laminate composite 60 of the press felt assembly 40 produces improved web groove depth and shape, thereby increasing bulk and improving the efficiency and usefulness of press felts in the paper and/or pulp sheet production processes, as compared to previous press felts. Further, one skilled in the art will appreciate the many other advantages of the press felt assembly 40, compared to previous press felts, not specifically described. In addition, it will be appreciated by one skilled in the art that the press felt assembly 40 including the multi-axial base 50 and the laminate composite 60 can be used in any other production process in which it is desired to imprint a pattern into or onto a production material. As such, the press felt assembly 40 including the multi-axial base 50 and the laminate composite 60 is not limited only to a paper, pulp, and/or tissue production process, as described in detail above.

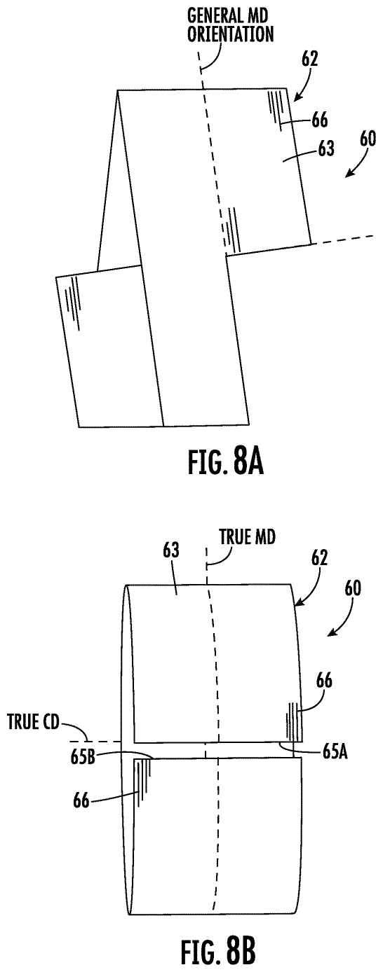

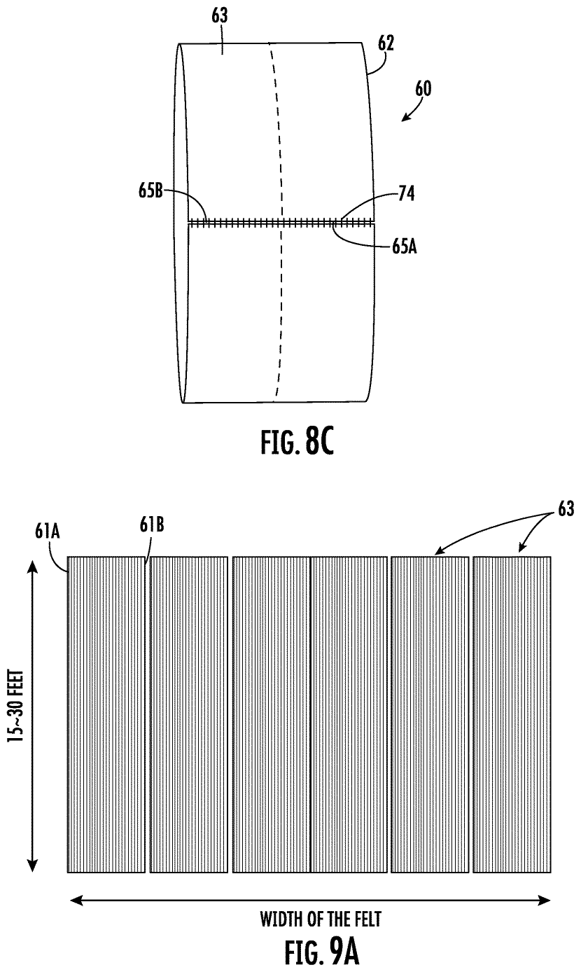

FIG. 8A-8C are a series of views showing the steps in an alternate example construction of the laminate composite 60, according to the present disclosure. Specifically, the laminate composite 60 of FIGS. 8A-8C includes the base layer 62 that is formed of at least one material strip 63 that includes generally MD oriented yarns 66 that are held together relative to one another by an adhesive layer or an additional fabric component, which could be generally CD oriented yarns or a nonwoven material, the scrim material 70, or another mesh material. In the illustrated embodiment, the fabric strip 63 is a nonwoven fabric strip which includes the generally MD oriented yarns 66 adhered to the base layer 62. The at least one material strip 63 has a width that is less than a CD width of the laminate composite 60 and adjacent longitudinal edges of the at least one material strip 63 are connected together, for example by bonding, fusing and/or stitching, in order to define an overall base layer 62 width. In the embodiment illustrated in FIG. 8A, the method includes spirally winding the at least one material strip 63 to form a spirally wound material strip 63 in which the MD yarns are canted from 1° to 8° from the true MD, and then cutting across the spirally wound material strip 63, realigning the cut ends 65A, 65B such that the generally MD oriented yarns 66 extend in the true MD as shown in FIGS. 8B and 8C.

In some embodiments, as illustrated in FIG. 8C, the method can further include joining the ends 65A, 65B together, for example by use of an adhesive scrim or tape, along a CD join path 74, to form a fabric loop of the laminate composite 60. Alternatively, more than one of the material strips 63 can be assembled directly into the configuration shown in FIG. 8B, with the longitudinal edges being joined to the longitudinal edges of adjacent ones of the material strips 63 in order to define an overall fabric width of the laminate composite 60 without spiral winding. Here, the generally MD oriented yarns 66 would be oriented in the true MD as shown in FIG. 8B, and the ends 65A, 65B are joined together, using an adhesive scrim or tape in order to form the CD join path 74 as noted above and shown in FIG. 8C to form the fabric loop of the laminate composite 60. This could be “socked” over the base fabric loop 50, discussed above, prior to needling.

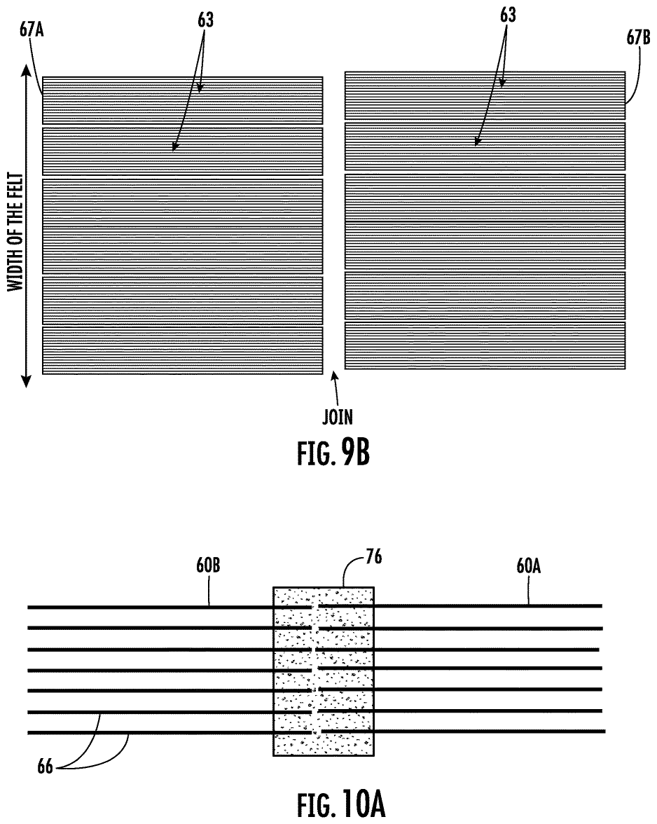

FIGS. 9A-9B illustrate a method for producing an endless nonwoven marking layer constructed from a plurality of assemblies 60A, 60B, etc. of strips 63 of the laminate composite as discussed above. Specifically, FIGS. 9A-9B illustrate a method of making a larger nonwoven laminate composite 60 by joining a plurality of laminate composite strips 63 together along adjacent longitudinal edges 61A, 61B of the laminate composite strips 63, as shown in FIG. 9A, to form assemblies 60A, 60B of the strips 63. After a plurality of laminate composite strips 63 are produced, each of the laminate composite strips 63 can be placed side by side in a widthwise direction. In the illustrated example, the length of each of the laminate composite strips 63 can range between 15-30 feet and the width of each of the laminate composite strips 63 can be about 3.3 feet (~1 meter). In other examples, the length and width can vary depending on the specific application.

As illustrated, each of the laminate composite strips 63 include a first longitudinal edge 61A and a second longitudinal edge 61B extending generally parallel to each other. To produce the endless nonwoven laminate composite marking layer 60, the plurality of individual laminate composite strips 63 are positioned side-by-side and adjacent first and a second longitudinal edges 61A, 61B are coupled together to form assembly 60A, 60B, etc. of the laminate composite strips 63. The number of individual laminate composite strips 63 in each of the assemblies 60A, 60B, etc. will depend on the desired width of the felt or marking layer to be produced. The adjacent first and a second longitudinal edges 61A, 61B can be coupled together, for example by adhesive scrim or tape, bonding, fusing, and/or stitching. In some examples, the bonding process used to connect the edges 61A, 61B can be an ultrasonic bonding process. In other examples, other bonding techniques and processes can be used.

Referring to FIG. 9B, once the assemblies 60A, 60B of laminate composite strips 63 have been created as previously described, the assemblies of the laminate composite strips 63 can be rotated 90-degress (compared to FIG. 9A), and two or more of the assemblies 60A, 60B, etc. of laminate composite strips 63 can be connected along their respective widthwise end. In other words, two or more of the assemblies 60A, 60B of laminate composite strips 63 can be aligned such that the yarns 66 of each assembly 60A, 60B are substantially parallel and then the adjacent widthwise ends (which are perpendicular to the longitudinal edges 61A, 61B) can be connected together, for example by an adhesive scrim or tape to form a longer fabric assembly. Additionally, the longer fabric assembly including a plurality of connected assemblies 60A, 60B, etc. of the laminate composite strips 63 (both in the widthwise and lengthwise directions) can be folded such the ends 67A, 67B are positioned adjacent, and then the ends 67A, 67B can be coupled together, for example by an adhesive scrim or tape, to form an endless loop of a nonwoven marking layer. While other connection techniques between the laminate composite longitudinal edges and ends could be used, such as bonding, fusing, or stitching, this is not necessary since in the finished press felt, the nonwoven marking layer is needled to the multi-axial (or other) base 50.

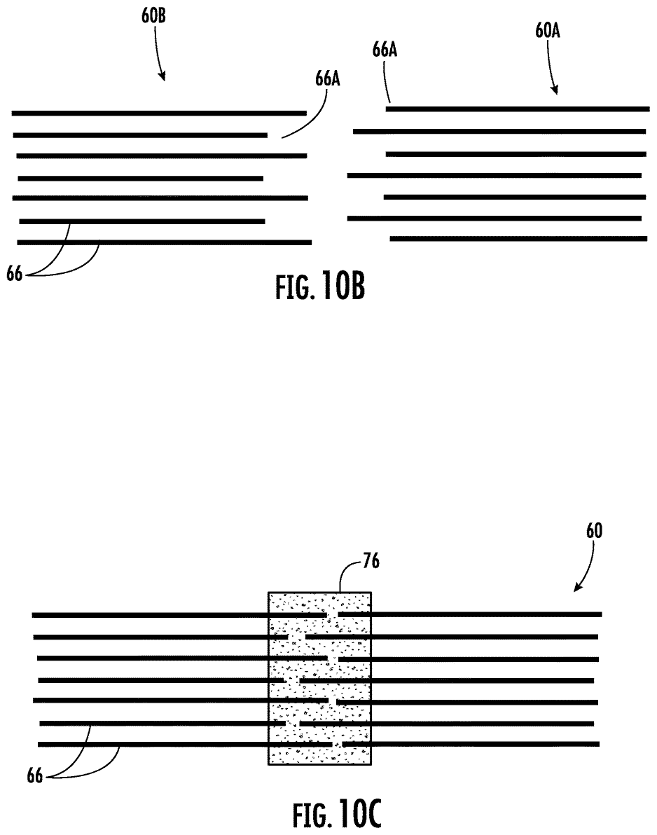

FIGS. 10A-10C illustrate different methods for joining ends of the assemblies 60A, 60B of the laminate composite strips 63 for forming the marking layer. As illustrated in FIG. 10A, in some examples, the ends of the yarns 66 of the assemblies 60A, 60B, etc. of the laminate composite strips 63 can be cut so they are generally parallel or aligned at their distal free ends. Then the assemblies 60A, 60B, etc. of the laminate composite strips 63 are aligned such that the yarns 66 are (ideally) aligned and parallel in their lengthwise directions. Once aligned, the ends of the yarns 66 and overall laminate composite assemblies 60A, 60B can be joined end-to-end using an adhesive scrim or tape 76. In some examples, as illustrated, the adhesive scrim or tape 76 can be made of a nylon. Further, in some examples, the adhesive scrim or tape 76 can be positioned on only one side of the laminate composite 60. In other examples, the adhesive scrim or tape 76 can be positioned on both sides of the laminate composite 60, to ensure a secure connection between adjacent assemblies 60A, 60B, etc. of the laminate composite strips 63.

As illustrated in FIGS. 10B-10C, in some examples, the ends 66A of the yarns 66 of the assemblies 60A, 60B, etc. of the laminate composite strips 63 can be cut so they are generally non-parallel or not aligned at their distal free ends 66A. Specifically, the ends 66A can be trimmed in a zig-zag or otherwise offset pattern such that the ends 66A are offset from every other yarn 66. The aforementioned can aid in ensuring that the yarns 66 of each of the individual assemblies 60A, 60B of the laminate composite strips 63 are (ideally) aligned and parallel in their lengthwise direction. Once aligned, the ends 66A of the yarns 66 and overall laminate composite assemblies 60A, 60B, etc. can be joined end-to-end using the adhesive scrim or tape 76. Further, in some examples, the adhesive scrim or tape 76 can be positioned on only one side of the laminate composite 60. In other examples, the adhesive scrim or tape 76 can be positioned on both sides of the laminate composite 60, to ensure a secure connection between adjacent assemblies 60A, 60B, etc. of the laminate composite strips 63.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

1. A press felt assembly comprising:
a multi-axial base having a cross-machine direction width, a machine direction length in a machine direction, and the multi-axial base being formed of a strip formed by a planar yarn array oriented at a nonparallel angle to the machine direction; and
a laminate composite connected to a surface of the multi-axial base, the laminate composite comprising:
a nonwoven base layer extending in the machine direction;
a first adhesive layer coupled to an upper surface of the base layer;
a plurality of marking yarns coupled to an upper surface of the first adhesive layer, the plurality of marking yarns being oriented in a generally machine direction;
a second adhesive layer coupled to the plurality of marking yarns, such that each of the plurality of marking yarns are positioned between the first adhesive layer and the second adhesive layer;
a nonwoven top layer extending in the machine direction, the top layer coupled to the second adhesive layer; and
a scrim material coupled to an upper surface of the second adhesive layer, such that the scrim material is positioned between the second adhesive layer and the top layer.

2. The press felt assembly of claim 1, wherein the generally machine direction comprises +/−3-5 degrees of a theoretical machine direction.

3. The press felt assembly of claim 1, wherein the plurality of marking yarns are oriented in a true machine direction.

4. The press felt assembly of claim 3, wherein the true machine direction comprises +/−1 degree of a theoretical machine direction.

5. (canceled)

6. The press felt assembly of claim 1, wherein the strip is a woven strip formed of interwoven warp and weft yarns, and the warp yarns extend at the nonparallel angle to the machine direction.

7. The press felt assembly of claim 1, wherein the strip is a nonwoven strip that includes yarns that extend at the nonparallel angle to the machine direction.

8. (canceled)

9. The press felt assembly of claim 1, further comprising at least one layer of a fibrous batt material connected to the laminate composite and the multi-axial base through a needling process.

10. The press felt assembly of claim 1, wherein the base layer is constructed from a nonwoven nylon backing material.

11. (canceled)

12. The press felt assembly of claim 1, wherein the first adhesive layer is constructed from a low-melt nylon adhesive web.

13. The press felt assembly of claim 1, wherein each of the plurality of marking yarns are constructed from a plurality of twisted multifilament yarns.

14. The press felt assembly of claim 1, wherein each of the plurality of marking yarns are constructed from a large monofilament yarn having a diameter greater than 0.5 mm.

15. The press felt assembly of claim 1, wherein the scrim material is constructed from one or more of a high-strength multifilament twisted with a low-melt adhesive and a monofilament yarn, a cabled monofilament yarn, a multifilament yarn, a twisted multifilament yarn, or any combination thereof, and wherein at least one intersecting yarn system of the scrim material contains a low-melt polymeric component.

16. The press felt assembly of claim 1, wherein the planar yarn array of the multi-axial base is oriented at the nonparallel angle with respect to the plurality of marking yarns of the laminate composite.

17. The press felt assembly of claim 3, wherein the plurality of marking yarns of the laminate composite are configured to form a plurality of grooves in a surface of a production material during a production process, each of the plurality of grooves being in the true machine direction.

18. A method of producing a press felt assembly, the method comprising:
producing and providing a multi-axial base including a planar yarn array;
laminating a laminate composite, the laminate composite comprising:
a base layer, a first adhesive layer adjacent the base layer, and a plurality of marking yarns coupled to the first adhesive layer;
a second adhesive layer coupled to the plurality of marking yarns, such that each of the plurality of marking yarns are positioned between the first adhesive layer and the second adhesive layer;
a nonwoven top layer extending in a machine direction, the top layer coupled to the second adhesive layer; and
a scrim material coupled to an upper surface of the second adhesive layer, such that the scrim material is positioned between the second adhesive layer and the top layer; and
connecting the laminate composite to the multi-axial base through a needling process, such that each of the plurality of marking yarns of the laminate composite are oriented generally parallel to a true machine direction of the press felt assembly.

19. (canceled)

20. (canceled)

21. The method of claim 18 and further comprising connecting at least one layer of a fibrous batt material to the press felt assembly through the needling process.

22. The method of claim 18, wherein producing the multi-axial base comprises:
spirally winding a fabric strip around a first roller and a second roller;
joining adjacent edges of the wound fabric strip to produce a double layer fabric structure;
coupling first seam loops at a first end of the double layer fabric structure to second seam loops at a second end of the double layer fabric structure; and
collapsing the coupled double layer fabric structure to form the multi-axial base with a cross-machine direction width and a machine direction length extending in the machine direction;
wherein generally MD oriented yarns of the planar yarn array of the woven multi-axial base are oriented at a nonparallel angle to the true machine direction.

23. The method of claim 18, wherein the plurality of marking yarns of the laminate composite are configured to form a plurality of grooves that are in the true machine direction in a surface of a production material during a production process.

24. The method of claim 18, further comprising forming the laminate composite by joining a plurality of laminate composite strips together at least one of along longitudinal edges of the laminate composite strips or along ends thereof in order to achieve a size of the multi-axial base.

25. (canceled)

26. (canceled)

27. A method of forming grooves in a pulp web during a pulp sheet production process, the method comprising:
providing a multi-axial base including generally machine direction oriented yarns of a planar yarn array that are oriented at a nonparallel angle to a true machine direction;
forming a laminate composite by joining a plurality of laminate composite strips together at least one of along longitudinal edges of the laminate composite strips or along ends thereof in order to achieve a size of the multi-axial base, the laminate composite comprising a base layer, a first adhesive layer adjacent the base layer, and a plurality of marking yarns coupled to the first adhesive layer, wherein each of the plurality of marking yarns of the laminate composite are oriented in the true machine direction;
connecting the laminate composite to the multi-axial base through a needling process to form a press felt assembly;
applying a paper web to the press felt assembly to produce the pulp web; and
forming, by each of the plurality of marking yarns of the laminate composite, a plurality of grooves in the pulp web, wherein each of the plurality of grooves in the pulp web are oriented in the true machine direction.
